(19) United States
(12) Patent Application Publication
(10) Pub. No.: US 2010/0097925 A1
(43) Pub. Date: Apr. 22, 2010

(54) SELECTIVE ROUTING TRAFFIC CONTROLS AND AUTOMATED RECOVERY AMONG PARALLEL MULTI-ACCESS INTERFACES

(75) Inventor: JON A. BELL, Raleigh, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 12/252,686

(22) Filed: Oct. 16, 2008

(51) Int. Cl. H04J 3/14

(52) U.S. Cl. 370/219; 370/235

(57) ABSTRACT

The present invention discloses a solution for automated interface switching among routing interfaces. In the solution, a routing daemon can be responsive to operator commands. Routing can be performed in a restricted parallel multi-access interface configuration comprised of a primary and backup interface for conveying routing protocol traffic. The backup interface can be utilized only when the associated primary interface is unavailable. The commands can include a suspend and an activate interface command able to modify the operation of one or more interfaces at the application layer. The suspend interface command can suppress network routing protocol traffic over a specified primary interface and route the traffic over the backup interface. The backup interface can then be designated as the primary interface for which the routing traffic can be conveyed. The activate interface command can activate a suspended interface and can be designated as a backup interface when a primary interface is available. When a primary interface is not available, the activate command can activate a suspended interface and designate the interface as the primary interface.

### BACKGROUND

The present invention relates to the field of computer networking and, more particularly, to automated interface switching among parallel multi-access interfaces.

In high availability networks involving the use of multi-access interfaces, a dynamic routing daemon is often used to route traffic efficiently over multiple interfaces. To provide failover support, routing daemons can be configured to operate in a restricted routing configuration. In this configuration, a primary and secondary (e.g., backup) interface is defined. The primary interface is used and in the event of a failure, the daemon switches routing traffic to the secondary interface.

Some network routing daemons have the ability to dynamically enable and disable a routing protocol feature on a particular interface. They do not have, however, the ability to provide automated switching to a parallel multi-access backup interface upon the primary interface outage or upon the disablement of a routing protocol feature on the primary interface. This is because a network routing daemon operates on the unrestricted model of employing all parallel multi-access interfaces simultaneously for routing protocol traffic to its neighboring routers. That is, there is no concept of primary and backup parallel multi-access interfaces in a network routing daemon. Even though a routing protocol feature can be disabled on certain parallel multi-access interfaces, there is still no automated switching between those interfaces.

Further, network routing daemons do not provide the option of suppressing or allowing all routing protocol traffic on a particular interface without disabling or enabling its routing protocol feature. While routing daemons may provide filters to control the routing protocol traffic on a particular interface with the routing protocol feature enabled, the daemon still require defining filters which they have to be maintained in terms of network changes. Current solutions can often be prohibitive, difficult to manage, and do not provide the granular control necessary.

### BRIEF DESCRIPTION OF THE SEVERAL VIEWS OF THE DRAWINGS

FIG. 1 is a schematic diagram illustrating a system for automated interface switching among parallel multi-access interfaces in accordance with an embodiment of the inventive arrangements disclosed herein.

FIG. 2 is a flowchart illustrating a method for suspending and activating a networking interface at the application layer in accordance with an embodiment of the inventive arrangements disclosed herein.

FIG. 3 is a schematic diagram illustrating an open systems interconnect (OSI) layered model for automated interface switching among parallel multi-access interfaces in accordance with an embodiment of the inventive arrangements disclosed herein.

FIG. 4 is a schematic diagram illustrating a set of scenarios for automated interface switching among parallel multi-access interfaces in accordance with an embodiment of the inventive arrangements disclosed herein.

### DETAILED DESCRIPTION

The present invention discloses a solution for automated interface switching among parallel multi-access interfaces. In the solution, a routing daemon can be responsive to operator commands in a restricted parallel multi-access interface configuration. The restricted parallel multi-access interface can include a primary and backup interface for conveying routing protocol traffic. The backup interface can be utilized only when the associated primary interface is unavailable. The commands can include a suspend and an activate interface command able to modify the operation of one or more interfaces at the application layer. The suspend interface command can suppress network routing protocol traffic over a specified primary interface and route the traffic over the backup interface. The backup interface can then be designated as the primary interface for which the routing traffic can be conveyed. The activate interface command can activate a suspended interface and can be designated as a backup interface when a primary interface is available. When a primary interface is not available, the activate command can activate a suspended interface and designate the interface as the primary interface.

It should be noted that the operator commands are not limited to parallel and multi-access interfaces. That is, while the automated interface switching applies to parallel and multi-access interfaces, the operator commands can be used for any routing interface in the application layer, which includes interfaces that are not parallel and/or not multi-access. In one embodiment, an operator using the operator commands can dynamically control routing traffic on a particular routing interface, regardless of specifics of that interface. The operating commands regardless of interface specifics can allow serviceability for the corresponding physical network interface. For example, maintenance, upgrade, or problem isolation can be performed on the physical interface without bringing down the routing daemon.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

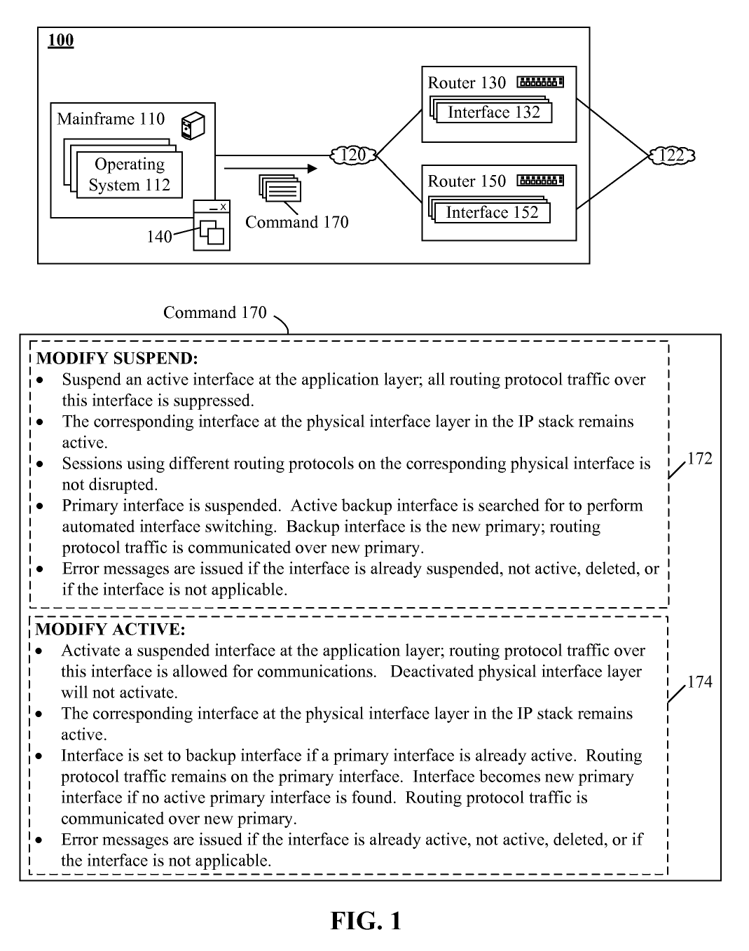

FIG. 1 is a schematic diagram illustrating a system 100 for automated interface switching among parallel multi-access interfaces in accordance with an embodiment of the inventive arrangements disclosed herein. In system 100, a routing application 140 executing on mainframe 110 can permit automated interface switching during suspension and activation of parallel multi-access interfaces 132, 152. Suspension and activation of parallel multi-access interfaces 132, 152 on routers 130, 150 can be performed through command 170. In system 100, interfaces 132, 152 can be designated as primary and backup interfaces to control the flow of routing protocol traffic between networks 120 and 122. For instance, interface 132 can be assigned as the primary interface and interface 152 can be designated as the backup interface. In this configuration, the primary interface 132 can route all traffic singly and the backup interface 152 can be used during an outage of the primary interface 132.

System 100 can include a multiplicity of operating systems 112 executing on mainframe 110. Each operating system 112 can be assisted by a routing application 140, enabling communication to and from operating systems 112 and network 120, 122 attached computing devices. In one embodiment, application 140 can be an IBM COMMUNICATION SERVER (CS) service associated with z/OS able to perform routing protocol functionality within a Virtual Internet Protocol Address (VIPA) scheme. The system 100 can be an autonomous system able to activate and/or suspend interfaces 132, 152 in response to user configured conditions. Alternatively, system 100 can permit manual user intervention to enable high availability to be maintained. Although only two routers 130, 150 are presented herein, the system 100 can include numerous multi-access interfaces.

Routers 130, 150 can be Autonomous Systems Boundary Routers (ASBR) able to support multiple routing protocols and exchange routing information between the routing protocols. Routing protocols supported by routers 130, 150 can include, but are not limited to Open Shortest Path First (OSPF), Routing Information Protocol version 1 (RIPv1), RIPv2, and the like. Routers 130, 150 can link network 120, 122 where network 120 can be an intranet and 122 can be an internet. In system 100, routers 130, 150 can operate in parallel providing failover support for a primary interface (e.g., interface 132) through a backup interface (e.g., interface 152). Automated interface switching can be performed by routing application 140 in association with router 130, 150 announcements and/or application 140 configuration settings.

Command 170 can be an operating system 112 command able to modify an interface 132, 152 operation. Command 170 can be a suspend command 172 or an activate command 174. In one embodiment, command 170 can be an application level command directing a change to a network routing application 140. Command 170 can enable application 140 to dynamically adjust primary and backup interfaces based on available interfaces. The command 170 can assist in problem determination process allowing administrative users to control specific routing traffic (e.g., OSPF) at the application layer.

In one embodiment, command 170 can be a modification to existing OMPROUTE commands. For instance, suspend and activate commands can follow the syntax where command 172, 174 is prefixed by the MODIFY command resulting in MODIFY SUSPEND and MODIFY ACTIVE.

The suspend 172 command can cause an active interface to be suspended at the application layer while not affecting traffic at the physical layer, unlike traditional interface control commands. The suspend 172 command can be used to suppress one or more routing protocol traffic over the suspended interface. Sessions utilizing different routing protocols can remain active without disruption. When a primary interface (e.g., interface 132) is suspended, an active backup interface (e.g., interface 152) can be determined by application 140. The backup interface can be designated as the new primary interface by application 140 and routing protocol traffic can flow over the interface. For instance, when the primary interface 132 is suspended, backup interface 152 can be assigned as the new primary interface.

The activate 174 command can cause a suspended interface to become active at the application layer while not affecting traffic at the physical layer common with traditional interface control commands. The activate 174 command can be used to allow one or more routing protocol traffic to be communicated over the newly activated interface. Interfaces deactivated at the physical interface layer are not modified and remain inactive. When an interface (e.g., interface 152) is activated and a primary interface (e.g., interface 132) is detected by application 140, the interface can be assigned as a backup interface. When no primary interface is detected, the backup interface can be designated as the new primary interface by application 140 and routing protocol traffic can flow over the interface.

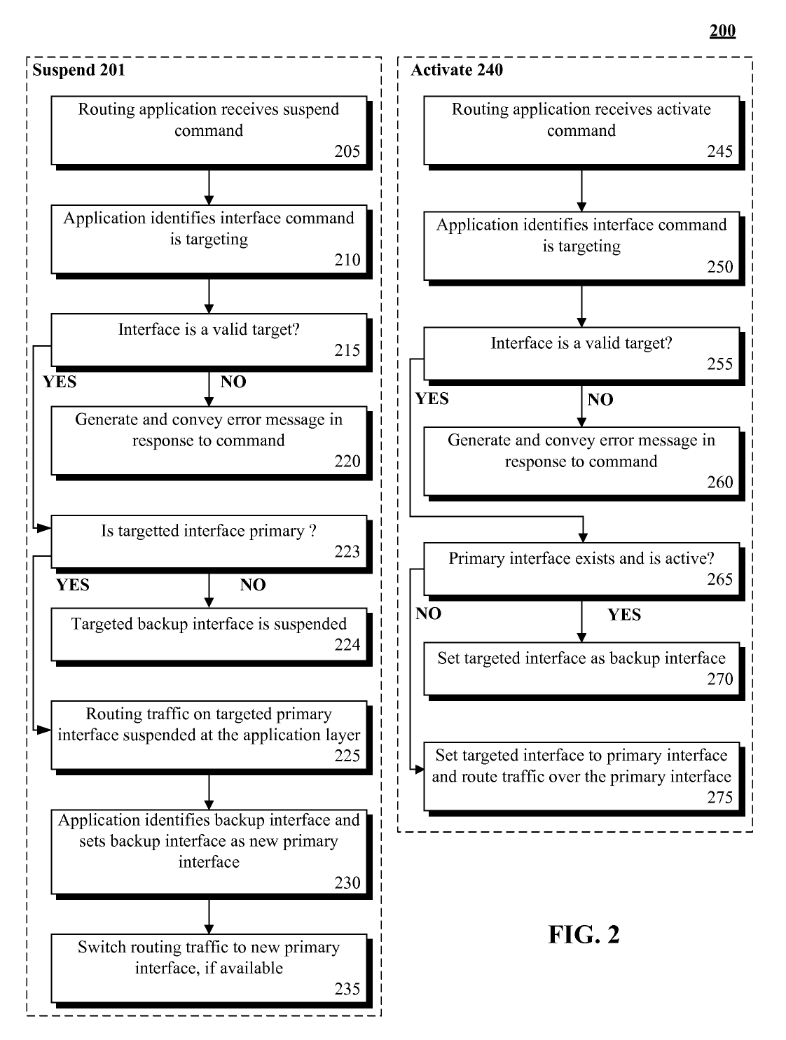

FIG. 2 is a flowchart illustrating a method 200 for suspending and activating a networking interface at the application layer in accordance with an embodiment of the inventive arrangements disclosed herein. Method 200 can be performed in the context of system 100. In method 200, a set of commands 201, 240 can enable automated switching of interfaces for routing traffic in a parallel multi-access environment. Suspend 201 command can allow an active interface to suspend routing traffic on the interface at the application layer. Activate 240 command can permit a suspended interface to be activated at the application layer and allow routing traffic to be conveyed over the interface. In method 200, routing traffic always flows on the primary interface, not the backup one. In an event of a primary interface outage or when the primary interface becomes suspended for any reason, the secondary interface can become a new primary interface, upon which traffic can flow.

Suspend 201 command can comprise steps 205-235, which can be performed on active interfaces. In step 205, a routing application (e.g., routing daemon) can receive a suspend command. In step 210, the application can identify an interface the command is targeting. If the interface is a valid target, the method can proceed to step 223, else continue to step 220. Invalid interfaces can result in the application error messages being conveyed to the command issuer. In step 220, error commands can be generated and conveyed in response to the command. The error commands can be presented for interfaces which are already suspended, inactive interfaces, deleted interfaces, and the like. Error messages can be configured to be presented to a user, conveyed to a message server/process, and/or recorded to a log file. In one embodiment, error messages can be conveyed to a syslogd process.

In step 223, a determination can be made as to whether the targeted interface is a primary interface. If not, the targeted backup interface can be suspended, as shown in step 224. If the interface is primary, step 225 can begin, where routing traffic on the targeted primary interface can be suspended at the application layer. In step 230, the routing application identifies the backup interface and sets the backup interface as a new primary interface. In step 235, traffic can be routed to the new primary interface, if available.

Activate 240 command can comprise steps 245-275, which can be performed on suspended interfaces. In step 245, a routing application can receive an activate command. In step 250, the application can identify the interface the command is targeting. In step 255, if the interface is valid, the method can proceed to step 265, else continue to step 260. Invalid interfaces can include interfaces which are already active, inactive interfaces, deleted interfaces, and the like. In step 260, the application can generate and convey an error message in response to the command. Error messages can be configured to be presented to a user, conveyed to a message server/process, and/or recorded to a log file. In step 265, if a primary interface exists and is active, the method can continue to step 270, else proceed to step 275. In step 270, the targeted interface can be set to the backup interface, which is used when the primary interface is unavailable. In step 275, the targeted interface can be set to the primary interface. Traffic can be routed over the primary interface.

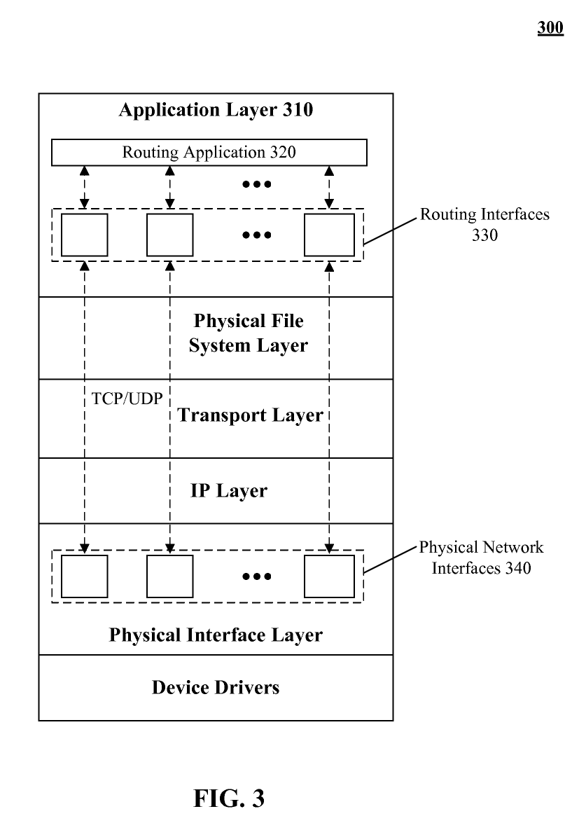

FIG. 3 is a schematic diagram illustrating an open systems interconnect (OSI) layered model 300 for automated interface switching among parallel multi-access interfaces in accordance with an embodiment of the inventive arrangements disclosed herein. Model 300 can be present in the context of system 100. Model 300 illustrates a routing application 320 performing routing protocol control at the application layer 310. In the model, each routing interface 330 has a one-to-one correspondence to a physical network interface 340 within the internet protocol stack (IP).

In one embodiment, routing software 320 can be an OMPROUTE routing daemon executing within an IBM z/OS computing environment. Application 320 can control suspend and/or activate routing interfaces 330 corresponding to physical network interfaces 340. Suspension of routing protocol traffic at the routing interface 330 can be performed without affecting other protocol traffic on the corresponding physical network interface 340.

Physical network interface 340 can be a physical terminating point for a network communication path. Interface can include, but is not limited to Ethernet, Fiber Distributed Data Interface (FDDI), and the like. Routing interfaces 330 can correspond to software abstractions of network interface 340. Interface 340 can include, but is not limited to, semaphores, network sockets, processes, threads, files, and the like.

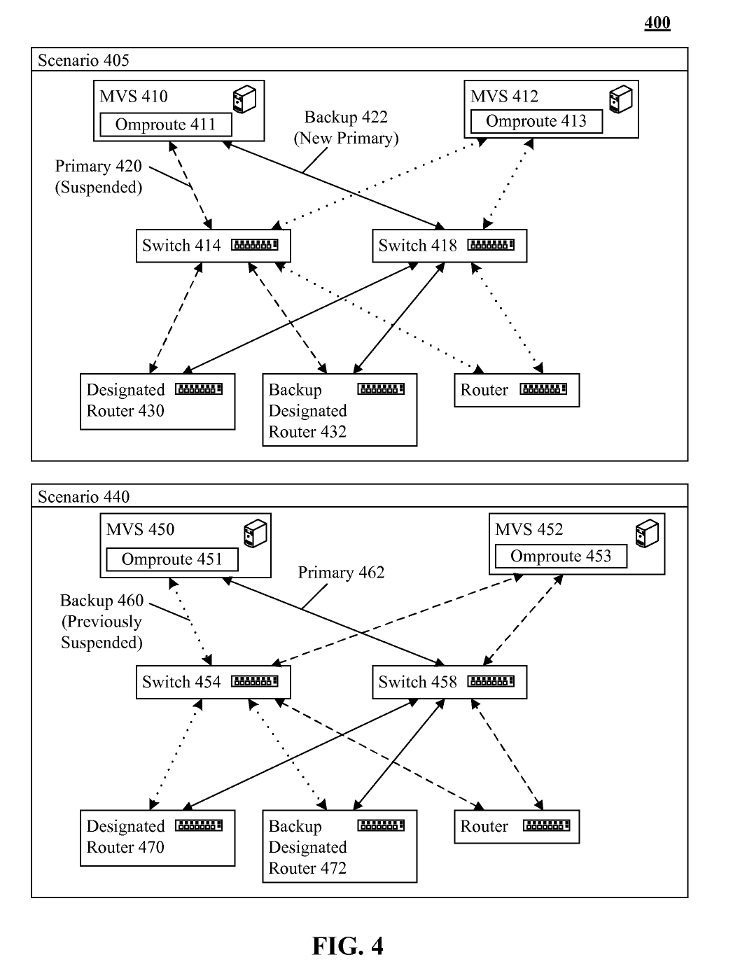

FIG. 4 is a schematic diagram illustrating a set of scenarios 405, 440 for automated interface switching among parallel multi-access interfaces in accordance with an embodiment of the inventive arrangements disclosed herein. In scenario 405, 440, a designated router (DR) 430, 470 and backup designated router (BDR) 432, 472 can provide parallel multi-access pathing for routing protocol traffic. Utilizing suspend and activate commands OMPROUTE 411, 413, 451 and 453 can perform automated interface switching for Open Shortest Path First (OSPF) routing protocol traffic in scenario 405, 440. In scenario 405, MULTIPLE VIRTUAL STORAGE (MVS) systems 410, 412 can be communicatively linked to switch 414, 418, DR 430, and BDR 432. In scenario 440, MVS system 450, 452 can be communicatively linked to switch 454, 458, DR 470, and BDR 472. Utilizing OMPROUTE 411, 413, 451, 453, an administrator can resolve routing tribulations by selectively activating or suspending parallel multi-access interfaces.

When a suspend command is issued to OMPROUTE 411, 413 the primary interface on DR 430 can be suspended. OSPF routing protocol traffic 420 to neighboring routers can be suppressed. All existing OSPF adjacencies over the DR 430 interface are destroyed. If there are static routes present over the physical interface of DR 430 which match the suspended interface in the application layer, the sessions using those routes will not be disrupted. A backup parallel interface on BDR 432 can be detected (e.g., router advertisements) and designated as the new primary. The OSPF routing protocol traffic 422 is allowed on the new primary interface on BDR 432 and OSPF adjacency formations are attempted over the new interface on BDR 432. If the physical interface on DR 430 matching the suspended interface on DR 430 in the application layer becomes deactivated, the suspended interface in DR 430 can transits to a DOWN state. After the interface reactivation, OMPROUTE 411, 413 can check if there is an active primary interface available. If an active primary interface is detected, the previously suspended interface can be marked as backup.

When an activate command is issued to OMPROUTE 451, 453 directed at suspended interface, OMPROUTE 451, 453 can take appropriate actions based on detected interfaces. If an active primary interface exists, backup interface on BDR 472 can be marked as active and designated as a backup multi-access interface. If no active primary interface on DR 470 is detected, the backup interface on BDR 472 can be marked active and designated the new primary interface. OSPF routing protocol traffic 462 can be switched over to the BDR 472 interface. For the new primary interface on BDR 472, OSPF protocol traffic 460 is allowed for communications with the neighboring routers. OSPF adjacency formations can be attempted with the designated routers in the network.

The flowchart and block diagrams in the FIGS. 1-4 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method for routing network traffic comprising:
identifying at least one of a plurality of routers within an operating environment, wherein the operating environment is a multi-path multi-protocol routing environment, wherein each router in the environment is associated with at least one of plurality of interfaces;
receiving a command to suspend traffic for one of a plurality of protocols associated with the router interface, wherein at least one protocol is suppressed on the interface;
suspending traffic for the suppressed protocol on the associated router interface, wherein the suspended routing interface is designated as a primary interface, wherein different protocols associated with the routing interface are unaffected;
responding to the suppressed protocol traffic, wherein the response is the changing of the routing interface to a backup routing interface, wherein the change is designating the backup interface as a primary interface for routing traffic of the suppressed protocol.

2. The method of claim 1, wherein the suspension of routing traffic occurs at the application layer within a routing daemon.

3. The method of claim 1, wherein the responding results in the activation of a suspended interface.

4. The method of claim 1, wherein the operating environment enforces a model comprising of at least one a primary interface and a backup interface.

5. The method of claim 1, wherein the suppressed protocol is a routing protocol.

6. The method of claim 1, wherein the suppressed protocol is at least one of Open Shortest Path First (OSPF) and Routing Information Protocol (RIP).

7. A system for routing network traffic comprising:
a routing daemon configured to identify a primary interface and a backup interface, wherein the backup interface is used to route traffic when a primary interface is unavailable.

8. The system of claim 7, wherein the primary interface and the backup interface is a multi-access interface.

9. The system of claim 7, wherein the routing daemon is OMPROUTE.

10. The system of claim 7, wherein the routing daemon operates in an environment corresponding to an OSI layered model of network communications, wherein an application layer is different from a physical layer and there exists a one-to-one correspondence between an application layer interface and a physical layer interface.

11. A system responsive to routing traffic commands comprising:
a routing daemon responsive to at least one of a plurality of commands able to modify the operation of an interface at the application layer, wherein the command is a suspend command and an activate command;
a primary interface able to convey at least one of a plurality of routing protocol traffic; and
a backup interface configured to convey at least one of a plurality routing protocol traffic when a primary interface is unavailable.

12. The system of claim 11, wherein the routing daemon response results in the corresponding interface at the physical interface layer in the Internet Protocol (IP) stack remaining active.

13. The system of claim 11, wherein the suspend command suspends an active interface at the application layer within the routing daemon resulting in routing protocol traffic suppression on the suspended interface.

14. The system of claim 11, wherein the suspend command results in routing traffic communicated over the backup interface.

15. The system of claim 11, wherein the activate command restores a suspended interface at the application layer within the routing daemon resulting in routing protocol traffic routed over the restored interface.

16. The system of claim 11, wherein the activate command results in the backup interface not routing traffic when the primary interface is available.

17. The system of claim 11, wherein a deactivated physical interface remains deactivated.
